(19) United States
(12) Patent Application Publication
(10) Pub. No.: US 2010/0243375 A1
(43) Pub. Date: Sep. 30, 2010

(54) STABILIZING DEVICE AND APPARATUS

(76) Inventors: John William Gaut, II, Virginia Beach, VA (US); Pamela Hassell Gaut, Virginia Beach, VA (US)

Correspondence Address: LAW OFFICE OF JERRY D. HAYNES , P.A, P.O. Box 350392, Fort Lauderdale, FL, 33335, US

(21) Appl. No.: 12/410,446

(22) Filed: Mar. 24, 2009

(51) Int. Cl. E06C 7/00

(52) U.S. Cl. 182/107

(57) ABSTRACT

The present invention relates to a stabilizing apparatus for stabilizing a ladder that may include: a stabilizing frame, where the frame includes a first end and a second end; at least two stabilizing legs, where the stabilizing legs include a means to attach to the stabilizing frame; and a means to adjust the length of the stabilizing legs once attached to the frame. A plurality of openings along an arm of each stabilizing leg, an opening at each end of the frame and a locking pin may provide the means for attachment. The means to adjust the length may include at least one row of a plurality of openings along an arm of each stabilizing leg. In one embodiment, the stabilizing leg may include an arm and an extension, where the extension extends from the arm at an angle.

### BACKGROUND OF INVENTION

1. Field of Invention

The present invention relates to a stabilizing device utilized on ladders.

2. Description of Related Art

Ladders are used in both industrial and residential environments to ascend walls and buildings in order to perform various construction. Ladders may be utilized with or without additional stabilizing devices. Stabilizing devices used in conjunction with ladders enable the user to stabilize the ladder while ascending or descending the ladder. Some stabilizers are positioned at the foot of the ladder and provide additional support at the foot, yet others are placed near the top of the ladder and provide stabilizing functions against the wall or building that the ladder may be mounted upon. Stabilizers used at the foot of the ladder address uneven surfaces that may make it difficult to use the ladder. Ladders are normally mounted against a wall or building and thus a stabilizer may be used near the top of the ladder and stabilize the ladder's resting point.

As can be recognized ladders are most effective on flat even surfaces however the use of ladders in various environments are not always conducive for a flat and even surface. One problem area involves mounting ladders at building corners. Although ladders may be positioned near the building corner it is difficult to position a ladder directly at a corner of a building without the use of some type of stabilizer. It would definitely be advantageous to have a stabilizer especially designed for use at a building corner to allow a means to position and firmly mount a ladder at a building corner.

### SUMMARY OF THE INVENTION

The present invention relates to a stabilizing apparatus for stabilizing a ladder comprising: a stabilizing frame, where the frame includes a first end and a second end; at least two stabilizing legs, where the stabilizing legs include a means to attach to the stabilizing frame; and a means to adjust the length of the stabilizing legs once attached to the frame. The means to attach may include a plurality of openings along an arm of each stabilizing leg, an opening at each end of the frame and a locking pin. The means to adjust the length may include at least one row of a plurality of openings along an arm of each stabilizing leg. The stabilizing leg may include an arm and an extension, where the extension extends from the arm at an angle and in one particular embodiment, the extension extends at a 90° angle from the arm after the arm is attached to the frame. In another exemplary embodiment, the stabilizing legs may include a means to attach a tool tray to the stabilizing legs after the legs are attached to the frame.

### BRIEF DESCRIPTION OF DRAWINGS

FIG. 1 depicts a straight frame according to the present invention.

FIG. 2A depicts a first stabilizing leg according to the present invention.

FIG. 2B depicts a second stabilizing leg according to the present invention.

FIG. 2C depicts a locking pin according to the present invention.

FIG. 3 depicts a side view of a tool tray according to the present invention.

### DETAILED DESCRIPTION

The present invention provides a stabilizing device and apparatus utilized with a ladder for mounting the ladder onto the corner of a building. Most stabilizers are designed for use on a flat surface such as the side of a building or against a wall. Such stabilizers are ineffective at the corner of a building and therefore limit the capability in mounting the ladder for ascension.

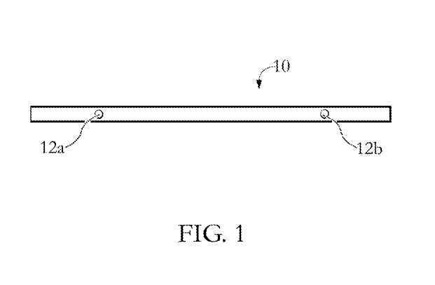

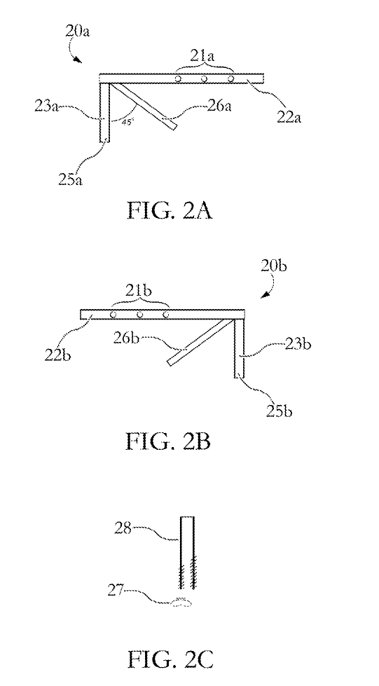

FIG. 1 depicts a straight frame 10 according to the present invention. The straight frame functions at the base of the stabilizer according to the present invention. The straight frame includes two openings 12a and 12b. The openings 12a and 12b are evenly spaced from each respective end of the straight frame 10. The straight frame 10 is used in conjunction with stabilizing legs 20a, 20b. The straight frame 10 is a hollow square tubing that allows for the insertion of stabilizing legs 20a, 20b. Stabilizing legs 20a, 20b are depicted in FIGS. 2A and 2B. The stabilizing legs 20a, 20b include adjustment arms 22a, 22b and stabilizing extensions 23a, 23b, respectively. Each respective stabilizing leg 20a, 20b inserts into the straight frame 10. The adjustment arm 22a inserts into a first end of the straight frame 10. The adjustment arm 22a includes a plurality of adjustment holes 21a. Although three adjustment holes are depicted in this particular environment, it's contemplated that a plurality of holes may be utilized along the adjustment arm 22a to provide a means to adjust the length of the stabilizing leg 20a. The stabilizing leg 20a is mounted to the frame 10 by aligning one of the adjustment holes 21a with opening 12a and locking the stabilizing leg 20a into place with a locking pin. Similarly stabilizing leg 20b may be inserted into the straight frame 10 at the opposite side of the frame 10. One of the holes 21b that is along the adjustment arm 22b aligns with the 12b opening and may be fixed into place with a locking pin.

Furthermore, each stabilizing leg 20a, 20b includes a stabilizing extension 23a, 23b. The stabilizing extension 23a, 23b extends outwardly from the adjustment arm 22 and may be set at a 90-degree angle from the adjustment arm. At this particular angle, the stabilizing legs 20a, 20b may be adjusted to a width to suit the particular need and to provide a firm mounting position for a ladder at a corner of a building. FIG. 2C shows a locking pin 28 according to the present invention. The locking pin 28 is used in conjunction with a wing nut 27 to lock the stabilizing legs 20a, 20b into a fixed position.

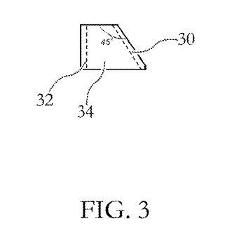

Also shown on stabilizing legs 20a, 20b are Velcro straps 26a, 26b. The Velcro straps 26a, 26b are used in conjunction with a small tool tray that may be placed across the straps and utilized by the user to store any necessary tools that may be used for his purposes while standing on the ladder. A tool tray 30 according to the present invention is depicted in FIG. 3. The tool tray 30 includes a magnetic strip 34 along the bottom side of the tool tray 30. The magnetic strip 34 helps to stabilize the tools that are placed within the tool tray and to prevent any loose tools from falling from the tray during use. Velcro strips are provided on the tool tray near the rear outside portion of the tray. The Velcro strips are joined with the Velcro straps 26a, 26b provided on the stabilizing legs 20a, 20b as a means to mount the tool tray into place.

Consequently the present invention provides a specific design of a stabilizer that is used to mount a ladder to a corner of a building during use thereof. The adjustment arms provided on the present invention enables the adjustment of the stabilizer to a suitable position to firmly mount the ladder against the building corner. Yet another advantage of the present invention is to include the use of a tool tray that mounts between the adjustable arms and holds any necessary tools that may be used or needed while working on the ladder.

What is claimed is:

1. A stabilizing apparatus for stabilizing a ladder comprising:
a. a stabilizing frame, where the frame includes a first end and a second end;
b. at least two stabilizing legs, where the stabilizing legs include a means to attach to the stabilizing frame; and
c. a means to adjust the length of the stabilizing legs once attached to the frame.

2. The stabilizing apparatus according to claim 1, where the means to attach includes a plurality of openings along an arm of each stabilizing leg, an opening at each end of the frame and a locking pin.

3. The stabilizing apparatus according to claim 1, where the means to adjust the length includes at least one row of a plurality of openings along an arm of each stabilizing leg.

4. The stabilizing apparatus according to claim 1, where each stabilizing leg includes an arm and an extension, where the extension extends from the arm at an angle.

5. The stabilizing apparatus according to claim 4, where the extension extends at a 90° angle from the arm after the arm is attached to the frame.

6. The stabilizing apparatus according to claim 1, where the stabilizing legs include a means to attach a tool tray to the stabilizing legs after the legs are attached to the frame.

7. The stabilizing apparatus according to claim 6, where the tool tray includes a magnetic surface.

8. The stabilizing apparatus according to claim 6, where the means to attach a tool tray includes Velcro strips within the extended stabilizing legs and a receptive Velcro strip along the side of the tool tray.
